(19) United States
(12) Patent Application Publication
(10) Pub. No.: US 2026/0166960 A1
(43) Pub. Date: Jun. 18, 2026

(54) Routing Thermally Conditioned Airflow Through a Vehicle Body

(71) Applicant: Nissan North America, Inc., Franklin, TN (US)

(72) Inventors: Logan Kluge, West Bloomfield, MI (US); Scott Cole, Whire Lake, MI (US)

(21) Appl. No.: 18/983,703

(22) Filed: Dec. 17, 2024

(51) Int. Cl. B60H 1/24; B60H 1/00

(52) U.S. Cl. CPC B60H 1/243; B60H 1/00564

(57) ABSTRACT

A vehicle is disclosed that includes a vehicle body and an HVAC system. The vehicle body includes: an inner panel; an outer panel connected to the inner panel so as to define a first cavity therebetween; and a trim panel connected to the inner panel so as to define a second cavity therebetween, wherein the inner panel, the outer panel, and the trim panel collectively define a body pillar. The HVAC system is supported by the vehicle body and includes: an HVAC case; a lower duct connected to the HVAC case; an inner duct connected to the lower duct; and an upper duct connected to the inner duct, wherein the HVAC case, the lower duct, and the upper duct are positioned externally of the first cavity and the inner duct is positioned internally within the first cavity such that the inner duct direct directs airflow through the body pillar.

### TECHNICAL FIELD

The present application relates to the heating, ventilation, and air conditioning (HVAC) system in a vehicle and, more specifically, to the routing of thermally conditioned airflow through a body pillar in the vehicle body.

### BACKGROUND

Modern vehicles include an increasing number of components, which can increase spatial constraints and complicate packaging, styling, and manufacturing. For example, in certain vehicles, airflow is routed through a duct that encroaches upon or otherwise extends into the passenger compartment and/or the storage compartment.

In an effort to address such concerns, the present disclosure provides an HVAC system that routes airflow through an inner duct that is concealed within the vehicle body (i.e., within one of the body pillars). Relocating and concealing the inner duct creates additional usable space (i.e., in the passenger compartment and/or the storage compartment), which increases styling flexibility and design freedom and fosters improvements in the packaging and the layout of the vehicle.

### SUMMARY

In one aspect of the present disclosure, a vehicle is disclosed that includes a vehicle body and an HVAC system.

The vehicle body includes: an inner panel; an outer panel that is connected to the inner panel so as to define a first cavity therebetween; and a trim panel that is connected to the inner panel so as to define a second cavity therebetween, wherein the inner panel, the outer panel, and the trim panel collectively define a body pillar.

The HVAC system is supported by the vehicle body and includes: an HVAC case; a lower duct that is connected to the HVAC case; an inner duct that is connected to the lower duct; and an upper duct that is connected to the inner duct, wherein the HVAC case, the lower duct, and the upper duct are positioned externally of the first cavity and the inner duct is positioned internally within the first cavity such that the inner duct directs airflow through the body pillar.

In certain embodiments, the HVAC case may include a blower.

In certain embodiments, the HVAC case, the lower duct, and the upper duct may be positioned inwardly of the inner panel.

In certain embodiments, the HVAC case, the lower duct, and the upper duct may contact an inner surface of the inner panel.

In certain embodiments, the inner duct may be positioned outwardly of the inner panel and inwardly of the outer panel.

In certain embodiments, the inner duct may be directly connected to the inner panel and indirectly connected to the outer panel.

In certain embodiments, the inner duct may contact an outer surface of the inner panel.

In certain embodiments, the inner duct may be welded to the inner panel and may be mechanically connected to the outer panel.

In certain embodiments, the inner duct may be configured such that airflow from the lower duct into the inner duct is redirected by approximately 90 degrees and such that airflow from the inner duct into the upper duct is redirected by approximately 90 degrees.

In certain embodiments, the HVAC system may further include an insulative member that extends about the inner duct to reduce thermal loss.

In another aspect of the present disclosure, a vehicle is disclosed that includes a vehicle body and an HVAC system that is supported by the vehicle body. The vehicle body includes a body pillar, and the HVAC system includes a duct that is positioned within the body pillar and which is configured to direct airflow therethrough. The duct includes: a conduit that defines a first end and a second end; a first end plate that is connected to the first end; a second end plate that is connected to the second end; an inlet port that is connected to the conduit adjacent to the first end; and an outlet port that is connected to the conduit adjacent to the second end.

In certain embodiments, the duct may be exclusively formed from a metallic material.

In certain embodiments, the conduit, the first end plate, the second end plate, the inlet port, and the outlet port may be configured as discrete components of the duct.

In certain embodiments, the first end plate, the second end plate, the inlet port, and the outlet port may be welded to the conduit.

In certain embodiments, the conduit may define a transverse cross-sectional dimension that varies between the first end and the second end.

In another aspect of the present disclosure, a vehicle is disclosed that includes a vehicle body and an HVAC system that is supported by the vehicle body. The vehicle body includes an inner metallic panel and an outer metallic panel that is connected to the inner metallic panel, and the HVAC system includes a duct that is directly connected to the inner metallic panel and indirectly connected to the outer metallic panel.

In certain embodiments, the duct may be welded to the inner metallic panel.

In certain embodiments, the HVAC system may further include a bracket that is connected to the duct and a fastener that extends through the outer metallic panel and into the bracket.

In certain embodiments, the bracket may be welded to the duct.

In certain embodiments, the bracket may be positioned between the outer metallic panel and the inner metallic panel.

### BRIEF DESCRIPTION OF THE DRAWINGS

According to common practice, certain components, elements, and/or features may be omitted from certain drawings in the interest of clarity.

FIG. 1 is a partial, inner, perspective view of a vehicle that includes a vehicle body and an HVAC system according to the principles of the present disclosure.

FIG. 2 is a partial, outer, perspective view of the vehicle illustrating the vehicle body and the HVAC system.

FIG. 3 is a partial, inner, perspective view of the vehicle shown with parts separated.

FIG. 4 is a cross-sectional view taken along line 4-4 in FIG. 1.

FIG. 5 is a cross-sectional view taken along line 5-5 in FIG. 1.

FIG. 6 is a cross-sectional view taken along line 6-6 in FIG. 1.

FIG. 7 is an enlargement of the area of detail identified in FIG. 3.

FIG. 8 is an enlargement of the area of detail identified in FIG. 7.

### DETAILED DESCRIPTION

The present disclosure describes an HVAC system for a vehicle that routes thermally conditioned air through an inner duct that is concealed within the vehicle body (i.e., within one of the body pillars) in order to create additional usable space in the passenger compartment and/or the storage compartment of the vehicle.

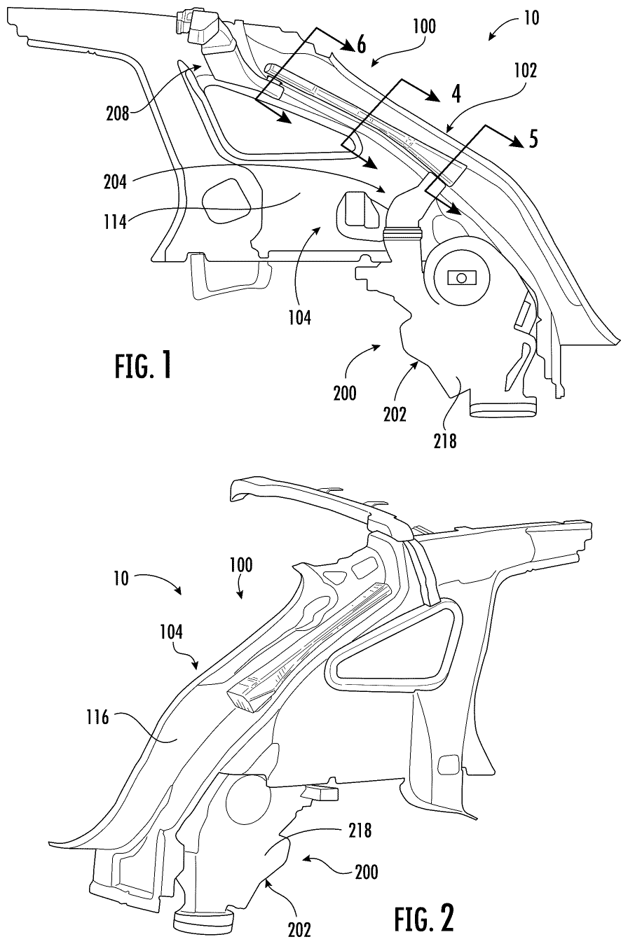

With reference to FIGS. 1-4, a vehicle 10 is disclosed that includes a vehicle body 100 and an HVAC system 200, which is supported by the vehicle body 100. Although generally illustrated and described in the context of a passenger vehicle, it should be appreciated that the principles of the present disclosure may be applied to a wide variety of vehicles (e.g., trucks, SUVs, vans, buses, boats, airplanes, trains, etc.).

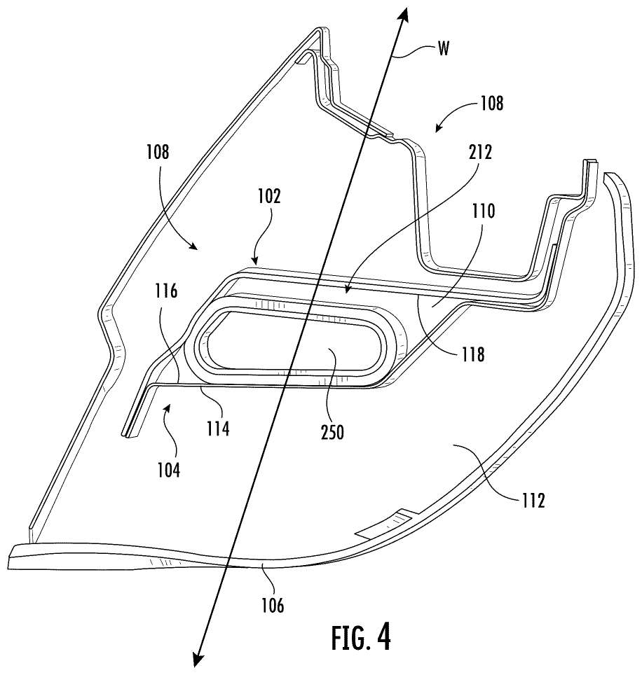

The vehicle body 100 is the main structural component of the vehicle 10 and includes: an outer panel 102; an inner panel 104; and a trim panel 106 (FIG. 4), which is omitted from FIGS. 1-3 for clarity. Collectively, the outer panel 102, the inner panel 104, and the trim panel 106 define a body pillar 108 (FIG. 4) of the vehicle body 100.

The outer panel 102 is connected (secured) to the inner panel 104 so as to define a (first) cavity 110 (FIG. 4) therebetween. More specifically, in the illustrated embodiment, the outer panel 102 and the inner panel 104 are welded together. It is envisioned, however, that the panels 102, 104 may be connected (secured) together in any suitable manner (e.g., via fasteners).

The trim panel 106 is connected (secured) to the inner panel 104 so as to define a (second) cavity 112 therebetween. While the trim panel 106 is mechanically connected (secured) to the inner panel 104 via fasteners in the illustrated embodiment, it is envisioned that the panels 102, 104 may be connected (secured) together in any suitable manner.

In the illustrated embodiment, the outer panel 102 and the inner panel 104 are metallic in construction, whereas the trim panel 106 is non-metallic in construction. More specifically, the outer panel 102 and the inner panel 104 each include (i.e., are formed from) sheet metal, and the trim panel 106 includes (i.e., is formed from) one or more plastic materials. It is envisioned, however, that the particular materials utilized in construction of the outer panel 102, the inner panel 104, and/or the trim panel 106 may be varied in alternate embodiments without departing from the scope of the present disclosure.

The HVAC system 200 thermally conditions (i.e., heats and/or cools) and directs air through the vehicle 10, as described in further detail below, and includes: an HVAC case 202; a lower (first) duct 204; a lower (first) seal 206; an upper (second) duct 208; an upper (second) seal 210; an inner (third) duct 212; brackets 214; and fasteners 216.

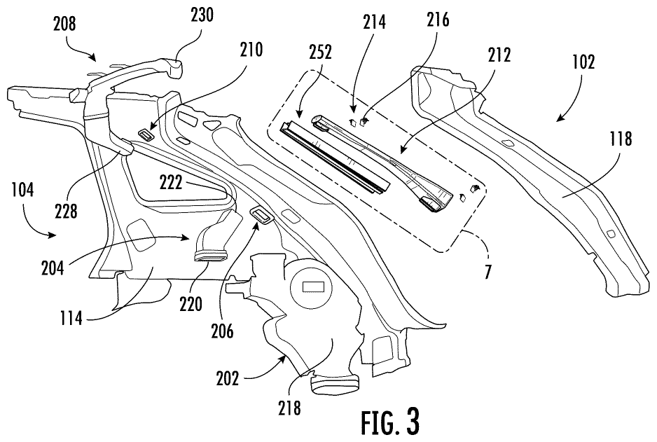

The HVAC case 202 is positioned (located) externally of the cavities 110, 112 and includes a variety of components (e.g., a blower 218, an evaporator, a thermal core, etc.) that draw in and thermally condition ambient air. More specifically, as seen in FIGS. 1 and 3, the HVAC case 202 is positioned (located) laterally inward of the inner panel 104 (i.e., an inner surface 114 thereof) along a width W (FIG. 4) of the vehicle 10.

In the illustrated embodiment, the HVAC case 202 is connected (secured) directly to the inner surface 114 of the inner panel 104 (e.g., via fasteners). It is envisioned, however, that the HVAC case 202 may be connected (secured) to, or otherwise supported by, the vehicle body 100 in any suitable location.

The lower duct 204 is positioned (located) externally of the cavities 110, 112 and laterally inward of the inner panel 104 (i.e., the inner surface 114 thereof) along the width W (FIG. 4) of the vehicle 10. The lower duct 204 includes a lower (first) end 220 (FIG. 3), which is in communication with the HVAC case 202, and an upper (second) end 222, which is in communication with the inner duct 212, whereby the lower duct 204 directs airflow from the HVAC case 202 (i.e., the blower 218) into the body pillar 108 (FIG. 4) via the inner duct 212, as described in further detail below.

The lower duct 204 (directly) contacts (e.g., is mounted to) the inner surface 114 of the inner panel 104 and, in the illustrated embodiment, extends into the lower seal 206, as described in further detail below. Embodiments in which the lower duct 204 may extend into the cavity 110 and/or the cavity 112 are also envisioned herein, however, as well as embodiments in which the lower duct 204 may be devoid of direct contact with the inner surface 114 of the inner panel 104 (e.g., depending upon the particular configuration of the vehicle 10, the location of the HVAC system 200, spatial constraints, manufacturing concerns, etc.). Embodiments are also envisioned in which the lower duct 204 may be exclusively positioned (located) laterally inward of the inner panel 104 (i.e., embodiments in which the lower duct 204 does not extend through or penetrate the inner panel 104).

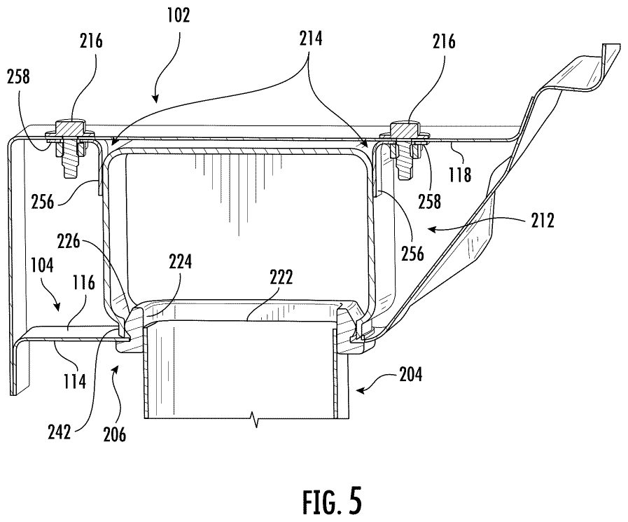

As seen in FIG. 5, the lower seal 206 creates a generally airtight, sealed interface between the lower duct 204, the inner panel 104, and the inner duct 212. Upon assembly of the HVAC system 200, the lower seal 206 receives the lower duct 204 and extends into the inner panel 104 and the inner duct 212. More specifically, the lower seal 206 defines an inner surface 224, which receives and seals with the upper end 222 of the lower duct 204, and an outer surface 226, which engages (contacts) and seals with the inner panel 104 and the inner duct 212. Embodiments are also envisioned, however, in which the lower seal 206 may be exclusively supported by (connected (secured) to) the inner duct 212 (i.e., such that the lower seal 206 is devoid of contact with the inner surface 114 of the inner panel 104).

The upper duct 208 is positioned (located) externally of the cavities 110, 112 and laterally inward of the inner panel 104 (i.e., the inner surface 114 thereof) along the width W (FIG. 4) of the vehicle 10. The upper duct 208 includes a lower (first) end 228, which is in communication with the inner duct 212, and an upper (second) end 230, which directs airflow from the inner duct 212 into the passenger compartment and/or the storage compartment of the vehicle 10 (e.g., via one or more vents).

The upper duct 208 (directly) contacts (e.g., is mounted to) the inner surface 114 of the inner panel 104 and extends into the upper seal 210, as described in further detail below. Embodiments in which the upper duct 208 may extend into the cavity 110 and/or the cavity 112 are also envisioned herein, however, as well as embodiments in which the upper duct 208 may be devoid of direct contact with the inner surface 114 of the inner panel 104 (e.g., depending upon the particular configuration of the vehicle 10, the location of the HVAC system 200, spatial constraints, manufacturing concerns, etc.). Embodiments are also envisioned in which the upper duct 208 may be exclusively positioned (located) laterally inward of the inner panel 104 (i.e., embodiments in which the upper duct 208 does not extend through or penetrate the inner panel 104).

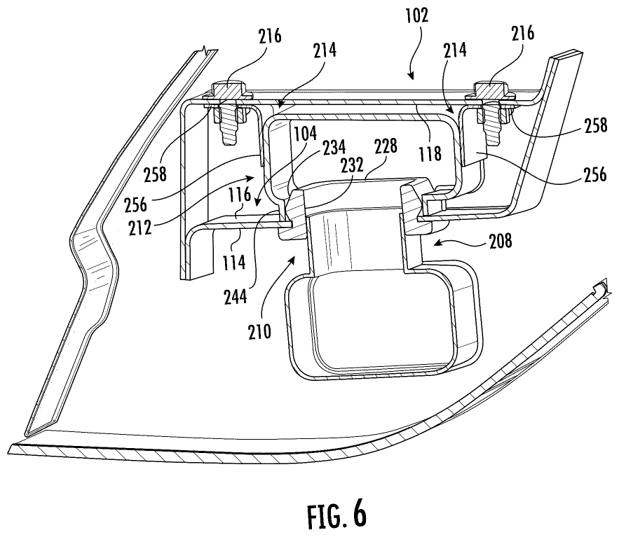

As seen in FIG. 6, the upper seal 210 creates a generally airtight, sealed interface between the upper duct 208, the inner panel 104, and the inner duct 212. Upon assembly of the HVAC system 200, the upper seal 210 receives the upper duct 208 and extends into the inner panel 104 and the inner duct 212. More specifically, the upper seal 210 defines an inner surface 232, which receives and seals with the lower end 228 of the upper duct 208, and an outer surface 234, which engages (contacts) and seals with the inner panel 104 and the inner duct 212.

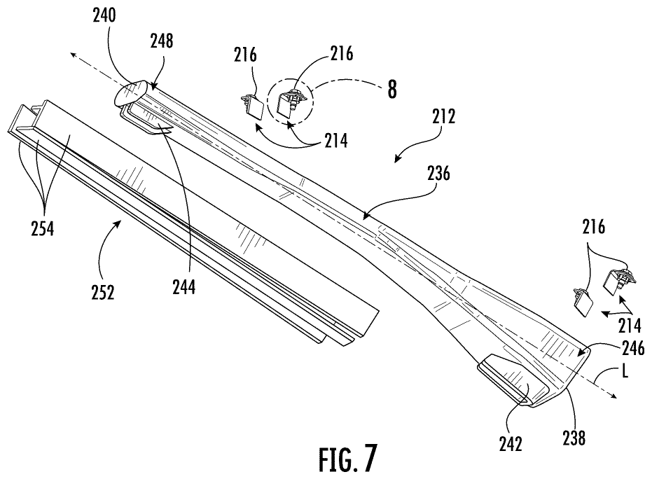

With reference now to FIG. 7 as well, the inner duct 212 will be discussed. The inner duct 212 is in communication with both the lower duct 204 and the upper duct 208, as indicated above, such that the inner duct 212 directs airflow from the lower duct 204, through the body pillar 108 (FIG. 4), to the upper duct 208. In contrast to certain known HVAC systems, in which airflow is often routed through a duct that is positioned (located) within, or extends into, the passenger compartment, the storage compartment, or between the inner panel 104 and the trim panel 106 (i.e., within the cavity 112), the inner duct 212 is positioned (located) within the body pillar 108 (i.e., internally within the cavity 110 (FIG. 4)). More specifically, whereas the HVAC case 202 and the respective lower and upper ducts 204, 208 are positioned (located) laterally inward of the inner panel 104, the inner duct 212 is positioned (located) laterally outward of the inner panel 104 (i.e., an outer surface 116 thereof) and laterally inward of the outer panel 102 (i.e., an inner surface 118 thereof) along the width W (FIG. 4) of the vehicle 10. Concealing the inner duct 212 within the body pillar 108 removes the inner duct 212 from the passenger compartment and/or the storage compartment of the vehicle 10, thereby increasing usable space, as indicated above.

Although shown as extending through a D-pillar in the illustrated embodiment, it is envisioned that the specific location of the inner duct 212 may be varied in alternate embodiments of the disclosure (e.g., depending upon the particular configuration of the vehicle 10, the location of the HVAC system 200, spatial constraints, manufacturing concerns, etc.). For example, embodiments are also envisioned in which the inner duct 212 may be positioned (located) within an A-pillar, a B-pillar, a C-pillar, etc.

In order to fix (secure) the inner duct 212 within the body pillar 108 (i.e., within the cavity 110), the inner duct 212 is connected (secured) to, or otherwise supported by, both the outer panel 102 and the inner panel 104. In the illustrated embodiment, the inner duct 212 is directly connected (secured) to (or is otherwise in contact with) the outer surface 116 of the inner panel 104 and is indirectly connected (secured) to (or is otherwise in contact with) the inner surface 118 of the outer panel 102. More specifically, the inner duct 212 is welded to the outer surface 116 of the inner panel 104 and is mechanically connected (secured) to the inner surface 118 of the outer panel 102 via the brackets 214 and the fasteners 216, as described in further detail below.

The inner duct 212 receives and directs airflow from the HVAC case 202 (i.e., the blower 218) and the lower duct 204 to the upper duct 208 through the body pillar 108, as indicated above, and includes: a conduit 236; a lower (first) end plate 238; an upper (second) end plate 240; an inlet (lower, first) port 242; and an outlet (upper, second) port 244.

The inner duct 212 is metallic in construction and, in the illustrated embodiment, is exclusively formed from sheet metal (e.g., steel, aluminum, etc.) as a hydroform. Embodiments in which the inner duct 212 may include one or more non-metallic materials are also envisioned herein (e.g., depending upon airflow requirements, the particular configuration of the vehicle 10, manufacturing concerns, costs, etc.), however.

The conduit 236 is generally tubular in construction and defines: a longitudinal axis L; a lower (first) end 246, which includes the lower end plate 238 and the inlet port 242; an upper (second) end 248, which includes the upper end plate 240 and the outlet port 244; and an internal passageway 250 (FIG. 4), which receives and directs airflow from the lower duct 204 to the upper duct 208. In the illustrated embodiment, the conduit 236 defines a generally ovate transverse cross-sectional configuration that varies in dimensions between the ends 246, 248, which is dictated by the specific configuration of the body pillar 108 (i.e., the cavity 110) and the position (location) thereof within the vehicle 10. More specifically, as seen in FIG. 7, the conduit 236 is tapered such that the transverse cross-sectional dimension is non-uniform between the ends 246, 248 and decreases from the lower end 246 towards the upper end 248. Embodiments in which the specific transverse cross-sectional configuration of the conduit 236 may be varied are also envisioned herein, however, as are embodiments in which the transverse cross-sectional dimensions of the conduit 236 may be generally uniform between the ends 246, 248 (e.g., depending upon the specific configuration of the body pillar 108, the specific position (location) of the body pillar 108 within the vehicle 10, spatial constraints, manufacturing concerns, etc.).

The end plates 238, 240 are connected (secured) to the conduit 236 adjacent to (at) the ends 246, 248 thereof, respectively. The end plates 238, 240 close the ends 246, 248 of the conduit 236 (i.e., the internal passageway 250), respectively, such that air exclusively flows through the conduit 236 via the inlet port 242 and the outlet port 244.

In the illustrated embodiment, the end plates 238, 240 are welded to the ends 246, 248 of the conduit 236. Embodiments in which the end plates 238, 240 may be mechanically connected (secured) to the conduit 236 (e.g., via fasteners) are also envisioned herein (e.g., depending upon the specific configuration of the body pillar 108, the specific position (location) of the body pillar 108 within the vehicle 10, spatial constraints, manufacturing concerns, etc.), however.

The inlet port 242 is spaced axially from the end plate 238 along the longitudinal axis L and is connected (secured) to the conduit 236 adjacent to (at) the end 246 thereof and to the inner panel 104. More specifically, the inlet port 242 is welded to both the end 246 of the conduit 236 and to the outer surface 116 of the inner panel 104.

As seen in FIG. 5, the inlet port 242 defines a (lower, first) opening, which is in communication with the internal passageway 250 and receives the lower seal 206 and the lower duct 204 (i.e., such that the lower seal 206 and the lower duct 204 each extend into the inlet port 242). The inner duct 212 is thus connected (secured) to the lower duct 204 via the inlet port 242 and the lower seal 206 such that air flows from the lower duct 204, through the lower seal 206 and the inlet port 242, into the conduit 236.

The outlet port 244 is spaced axially from the end plate 240 along the longitudinal axis L and is connected (secured) to the conduit 236 adjacent to (at) the end 248 thereof and to the inner panel 104. More specifically, the outlet port 244 is welded to both the end 248 of the conduit 236 and to the outer surface 116 the inner panel 104.

As seen in FIG. 6, the outlet port 244 defines an (upper, second) opening, which is in communication with the internal passageway 250 and receives the upper seal 210 and the upper duct 208 (i.e., such that the upper seal 210 and the upper duct 208 each extend into the outlet port 244). The inner duct 212 is thus connected (secured) to the upper duct 208 via the outlet port 244 and the upper seal 210 such that air flows from the conduit 236, through the upper seal 210 and the outlet port 244, into the upper duct 208.

In the illustrated embodiment, the inlet port 242 and the outlet port 244 extend from the conduit 236 in generally orthogonal (perpendicular) relation (i.e., at approximately 90 degrees in relation to the longitudinal axis L (FIG. 7)), which is dictated by the specific configuration of the body pillar 108 (i.e., the cavity 110), the position (location) of the body pillar 108 within the vehicle 10, the relative positions (locations) of the lower duct 204 and the upper duct 208, etc. The inner duct 212 is thus configured such that airflow from the lower duct 204 into the inner duct 212 is redirected by approximately 90 degrees and such that airflow from the inner duct 212 into the upper duct 208 is redirected by approximately 90 degrees. Embodiments in which the inner duct 212 may be configured to direct airflow through vehicle 10 in a generally linear manner are also envisioned herein (i.e., depending on the particular configuration of the vehicle 10, the position (location) of the inner duct 212, etc.), however.

Although shown as being welded to the conduit 236, embodiments in which the respective inlet and outlet ports 242, 244 may be mechanically connected (secured) to the conduit 236 (e.g., via fasteners) are also envisioned herein (e.g., depending upon the specific configuration of the body pillar 108, the specific position (location) of the body pillar 108 within the vehicle 10, spatial constraints, manufacturing concerns, etc.), however.

In the illustrated embodiment, the conduit 236, the end plates 238, 240, and the ports 242, 244 are configured as discrete components of the inner duct 212, which allows for assembly of the inner duct 212 and the HVAC system 200 in a manner that accommodates spatial constraints and the particular position (location) of the inner duct 212. Embodiments in which the inner duct 212 may be unitary (monolithic) in construction (i.e., such that the conduit 236, the end plates 238, 240, and the ports 242, 244 are formed from a single piece of metallic or non-metallic material) are also envisioned herein (e.g., depending upon the specific configuration of the body pillar 108, the specific position (location) of the body pillar 108 within the vehicle 10, spatial constraints, manufacturing concerns, etc.), however.

Although the respective inlet and outlet ports 242, 244 are shown as extending through the inner panel 104 from the conduit 236, embodiments are also envisioned in which the inner duct 212 may be entirely (exclusively) positioned (located) within the cavity 110 (i.e., embodiments in which the inner duct 212 does not extend through or penetrate the inner panel 104). For example, embodiments are envisioned in which the inlet and outlet ports 242, 244 may be included on the lower and upper ducts 204, 208, respectively, as are embodiments in which the inlet and outlet ports 242, 244 may be included on the lower and upper seals 206, 210, respectively.

In the illustrated embodiment, the HVAC system 200 further includes an insulative member 252 (FIGS. 3, 7), which may be connected (secured) to the inner duct 212 in any suitable manner (e.g., via an adhesive). The insulative member 252 reduces noise and thermal loss, thereby increasing the efficiency of the HVAC system 200 and may include (e.g., may be formed from) any suitable thermally insulative material.

In the illustrated embodiment, the insulative member 252 includes a plurality of discrete panels 254 of insulative material that are positioned (located) externally of the inner duct 212 such that the insulative member 252 extends about (e.g., circumscribes) the inner duct 212. Embodiments in which the insulative member 252 may be unitary (monolithic) in construction (i.e., such that the insulative member 252 is configured as a sleeve that is formed from a single piece of insulative material) are also envisioned herein (e.g., depending upon the specific configuration of the body pillar 108, the specific position (location) of the body pillar 108 within the vehicle 10, spatial constraints, manufacturing concerns, etc.), however, as are embodiments in which the insulative member 252 may be positioned (located) within the inner duct 212.

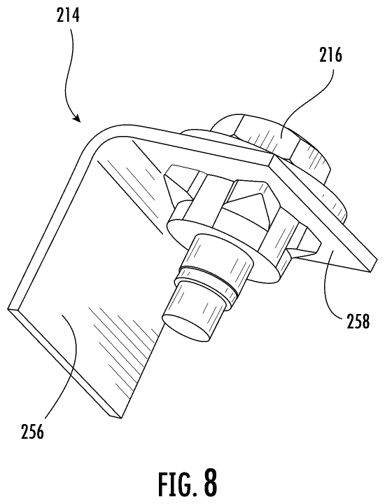

With reference to FIG. 8 as well, the brackets 214 and the fasteners 216 will be discussed, which collectively connect (secure) the inner duct 212 to the outer panel 102.

The brackets 214 are positioned (located) between the inner panel 104 and the outer panel 102 (i.e., within the cavity 110), and include (first) legs 256 and (second) legs 258, which are oriented in generally orthogonal (perpendicular) relation to the legs 256. The legs 256 are connected (secured) to the inner duct 212, and the legs 258 are connected (secured) to the outer panel 102. More specifically, as seen in FIG. 5, for example, the legs 258 abut the inner surface 118 of the outer panel 102, and the fasteners 216 extend through the outer panel 102 and the legs 258 into the brackets 214, thereby connecting (securing) the inner duct 212 to the outer panel 102. As a result of the connection between the outer panel 102 and the inner duct 212 established by the brackets 214, in addition to directing airflow, the inner duct 212 acts as a structural member that reinforces (fortifies) the body pillar 108, increasing the strength (rigidity) thereof.

In the illustrated embodiment, the legs 256 are welded to the inner duct 212. Embodiments in which the brackets 214 may be mechanically connected (secured) to the inner duct 212 (e.g., via fasteners) are also envisioned herein (e.g., depending upon the specific configuration of the body pillar 108, the specific position (location) of the body pillar 108 within the vehicle 10, spatial constraints, manufacturing concerns, etc.), however.

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A vehicle comprising:
a vehicle body including:
an inner panel;
an outer panel connected to the inner panel so as to define a first cavity therebetween; and
a trim panel connected to the inner panel so as to define a second cavity therebetween, wherein the inner panel, the outer panel, and the trim panel collectively define a body pillar; and
a heating, ventilation, and air conditioning (HVAC) system supported by the vehicle body, wherein the HVAC system includes:
an HVAC case;
a lower duct connected to the HVAC case;
an inner duct connected to the lower duct; and
an upper duct connected to the inner duct, wherein the HVAC case, the lower duct, and the upper duct are positioned externally of the first cavity and the inner duct is positioned internally within the first cavity such that the inner duct directs airflow through the body pillar.

2. The vehicle of claim 1, wherein the HVAC case includes a blower.

3. The vehicle of claim 1, wherein the HVAC case, the lower duct, and the upper duct are positioned inwardly of the inner panel.

4. The vehicle of claim 3, wherein the HVAC case, the lower duct, and the upper duct contact an inner surface of the inner panel.

5. The vehicle of claim 3, wherein the inner duct is positioned outwardly of the inner panel and inwardly of the outer panel.

6. The vehicle of claim 5, wherein the inner duct is directly connected to the inner panel and indirectly connected to the outer panel.

7. The vehicle of claim 6, wherein the inner duct contacts an outer surface of the inner panel.

8. The vehicle of claim 6, wherein the inner duct is welded to the inner panel and is mechanically connected to the outer panel.

9. The vehicle of claim 5, wherein the inner duct is configured such that airflow from the lower duct into the inner duct is redirected by approximately 90 degrees and such that airflow from the inner duct into the upper duct is redirected by approximately 90 degrees.

10. The vehicle of claim 1, wherein the HVAC system further includes:
an insulative member extending about the inner duct to reduce thermal loss.

11. A vehicle comprising:
a vehicle body including a body pillar; and
a heating, ventilation, and air conditioning (HVAC) system supported by the vehicle body, wherein the HVAC system includes:
a duct positioned within the body pillar and configured to direct airflow therethrough, wherein the duct includes:
a conduit defining a first end and a second end;
a first end plate connected to the first end;
a second end plate connected to the second end;
an inlet port connected to the conduit adjacent to the first end; and
an outlet port connected to the conduit adjacent to the second end.

12. The vehicle of claim 11, wherein the duct is exclusively formed from a metallic material.

13. The vehicle of claim 11, wherein the conduit, the first end plate, the second end plate, the inlet port, and the outlet port are configured as discrete components of the duct.

14. The vehicle of claim 13, wherein the first end plate, the second end plate, the inlet port, and the outlet port are welded to the conduit.

15. The vehicle of claim 11, wherein the conduit defines a transverse cross-sectional dimension varying between the first end and the second end.

16. A vehicle comprising:
a vehicle body including:
an inner metallic panel; and
an outer metallic panel connected to the inner metallic panel; and
a heating, ventilation, and air conditioning (HVAC) system supported by the vehicle body, wherein the HVAC system includes:
a duct directly connected to the inner metallic panel and indirectly connected to the outer metallic panel.

17. The vehicle of claim 16, wherein the duct is welded to the inner metallic panel.

18. The vehicle of claim 16, wherein the HVAC system further includes:
a bracket connected to the duct; and
a fastener extending through the outer metallic panel and into the bracket.

19. The vehicle of claim 18, wherein the bracket is welded to the duct.

20. The vehicle of claim 18, wherein the bracket is positioned between the outer metallic panel and the inner metallic panel.
